(19) United States
(12) Patent Application Publication
(10) Pub. No.: US 2024/0276907 A1
(43) Pub. Date: Aug. 22, 2024

(54) Potassium Boron-Containing Fertilizer and Process

(71) Applicant: U.S. Borax Inc., Wilmington, DE (US)

(72) Inventors: Cleiton De Sequeira, Aurora, IL (US); Flavio Barcelos Cardoso, Sao Paulo (BR); Wendall Boehje, Wyalusing, WI (US)

(21) Appl. No.: 18/570,720

(22) PCT Filed: Jun. 10, 2022
(86) PCT No.: PCT/US2022/032942

§ 371 Date: Dec. 15, 2023

Related U.S. Application Data
(60) Provisional application No. 63/212,411, filed on Jun. 18, 2021.

(51) Int. Cl. A01C 21/00; A01G 22/20; A01G 22/40; C05D 1/00; C05G 5/27

(52) U.S. Cl. CPC A01C 21/005; A01G 22/20; A01G 22/40; C05D 1/00; C05G 5/27

(57) ABSTRACT

The present disclosure provides a process. In an embodiment, the process includes providing a stable aqueous suspension composed of from 30% (w/w) to 60% (w/w) suspended particles of potassium pentaborate, and spraying the suspension on a plant at a rate from 0.20 lbs/acre to 0.70 lbs/acre.

### BACKGROUND

Potassium (K) is important to plant life, and is one of the three main macronutrients that promotes strong stem growth, movement of water in plants, flowering, and fruiting. In particular, potassium is important for the loading of sucrose and enhancing the rate of mass-driven solute transport in the phloem. For example, potassium enables a high pH to be maintained in the phloem for sucrose loading, and contributes to the osmotic potential in the phloem tubes and, thus, the transport rates of photosynthates from source (e.g., leaves) to sink (e.g., roots, young shoots, and developing seed). In potassium-sufficient plants, about half of the carbon-labelled photosynthates are exported from the source leaf to other organs within about 90 minutes. In contrast, in potassium-deficient plants, the export rates are much lower, even after 4 hours. (Hawkestfor, M et al., Functions of Macronutrients. In Marschner, P. 2012. Mineral Nutrition of Higher Plants).

Boron (B) is an essential micronutrient needed for normal plant growth and development. Boron is involved in many plant processes such as sugar transport, cell wall synthesis, lignification, meristematic tissue cell division, petal and leaf bud formation, cell wall structure integrity, sugar and hydrocarbon metabolism and their transport, ribose nucleic acid (RNA) metabolism, respiration, indole acetic acid (IAA) metabolism, cytokinin production and transfer, phenol metabolism, nitrogen fixation, pollen germination, pollen tube formation and seed formation.

The role of boron in plant growth was discovered in the 1920s and since then, boron deficiency is found in many crops. Boron deficiency shows in clearly defined ways in certain crops. Generally, by the time visible symptoms are seen, yields will already have been adversely affected. The best way to establish boron need is either through soil testing or through tissue analysis. In this way, boron supplementation can form part of a ‘balanced nutrition’ approach to crop fertilization.

Maintaining a proper balance of potassium and boron nutrients during plant growth is important for optimizing plant growth and promoting fruitful harvests of crops. Consequently, the art recognizes the need for compositions containing potassium and boron formulated for application to, and uptake by, plants. The art further recognizes the need for processes that apply potassium/boron-containing compositions to nourish plants and increase harvest yield.

### SUMMARY

The present disclosure provides a process. In an embodiment, the process includes providing a stable aqueous suspension composed of from 30% (w/w) to 60% (w/w) suspended particles of potassium pentaborate, and spraying the suspension on a plant at a rate from 0.20 lbs/acre to 0.70 lbs/acre.

### BRIEF DESCRIPTION OF THE DRAWING

FIG. 1 is a graph showing alfalfa dry matter yield for foliar solutions applied to alfalfa for comparative samples and an inventive example.

### DEFINITIONS

In order for the present disclosure to be more readily understood, certain terms are first defined below. Additional definitions for the following terms and other terms are set forth throughout the specification.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., from 1 or 2, or 3 to 5, or 6, or 7), any subrange between any two explicit values used herein is included (e.g., the range 1-7 above includes the subranges from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The term “suspension” is a system in which particles are uniformly dispersed in a liquid medium.

The term “(w/w)” refers to weight/weight (or weight to weight) and represents a weight of a compound or chemical entity relative to a total weight of the composition or suspension. The “w/w” is the mass (in grams) of the compound (or solute) divided by the mass (in grams) of the total suspension (or solution) with result reported in percent, or “%”.

### Test Methods

Average particle size for the potassium pentaborate particles is measured with a Beckman-Coulter LS230 laser diffraction particle size analyzer.

Bulk density is the mass of the suspension divided by the volume of the suspension with result reported in grams (g) per milliliter (mL), g/mL.

Dynamic viscosity is a fluid's resistance to flow and is measured by a Brookfield viscometer, at 20 rpm, using RV spindle #4.

The term pH is a measure of the hydrogen ion concentration in a solution. The pH is measured in accordance with ASTM E70 testing procedure for measuring pH of a solution with a glass electrode.

### DETAILED DESCRIPTION

The present disclosure provides a process. In an embodiment, the process includes providing a stable aqueous suspension composed of particles of potassium pentaborate.

The stable aqueous suspension includes from 30% (w/w) to 60% (w/w) suspended particles of potassium pentaborate. The process includes spraying the suspension on a plant at a rate from 0.20 pounds (lbs)/acre to 0.70 lbs/acre. Potassium pentaborate has a chemical formula of K₂O·(B₂O₃)₅·8H₂O. The stable aqueous suspension further includes at least 8% (w/w) boron and at least 5% (w/w) potassium oxide (K₂O). In an embodiment, the suspension contains potassium pentaborate to the exclusion of sodium, or otherwise in the absence of sodium.

The term “stable aqueous suspension with particles of potassium pentaborate,” (interchangeably referred to as “stable aqueous suspension”) as used herein, is an aqueous suspension with particles of suspended potassium pentaborate that exhibits (i) no potassium pentaborate particles (interchangeably referred to as “potassium pentaborate crystals”) visibly perceptible to the naked eye and (ii) no settlement of potassium pentaborate particles visibly perceptible to the naked eye after the stable aqueous suspension has been stored at ambient conditions (i.e., a temperature from 5° C. to 25° C.) for at least two weeks (or at least 14 days). In other words, the suspended potassium pentaborate particles are so small that an onlooker observing (with the naked eye) the stable aqueous suspension containing the particles of potassium pentaborate cannot see, or otherwise cannot visually detect: (i) any discrete potassium pentaborate particles in suspension and/or (ii) any settlement of potassium pentaborate particles (or other particles) within the aqueous suspension.

In an embodiment, the stable aqueous suspension with particles of potassium pentaborate exhibits no potassium pentaborate particles that are visibly perceptible to the naked eye after the stable aqueous suspension has been stored at ambient conditions for a duration from two weeks, or four weeks, or 8 weeks to 10 weeks, or 12 weeks or 16 weeks or more.

The stable aqueous suspension includes particles of potassium pentaborate in an amount from 30% to 60% (w/w). In an embodiment, the stable aqueous suspension includes particles of potassium pentaborate in an amount from 30% (w/w), or 31%, or 32%, or 33%, or 34%, or 35%, or 36%, or 37%, or 38%, or 39%, or 40%, or 41%, or 42%, or 43%, or 44%, or 45% to 46%, or 47%, or 48%, or 49%, or 50%, or 51%, or 52%, or 53%, or 54%, or 55%, or 56%, or 57%, or 58%, or 59%, or 60% (w/w).

In an embodiment, the stable aqueous suspension includes boron in an amount from 8% (w/w) to 13% (w/w) and from 5% to 20% (w/w) potassium oxide. In a further embodiment, the stable aqueous suspension includes from 8% (w/w), or 9%, or 10%, to 11%, or 12%, or 13% (w/w) boron, and from 5% (w/w), or 6%, or 7%, or 8%, or 9%, or 10%, or 11%, or 12%, or 13% to 14%, or 15%, or 16%, or 17%, or 18%, or 19%, or 20% (w/w) potassium oxide, or more.

The potassium pentaborate particles in the stable aqueous medium have an average particle size from 1 μm to less than 100 μm. The term “average particle size” refers to the diameter of the potassium pentaborate particles in the suspension. For potassium pentaborate particles that are not spherical, the diameter of the potassium pentaborate particle is the average of the long and short axes of the particle. Laser-diffraction techniques are used to measure potassium pentaborate particle size. Average particle size may be measured on a Beckman-Coulter LS230 laser-diffraction particle size analyzer or other suitable device, for example.

In an embodiment, the potassium pentaborate particles have an average particle size from 1 μm to 90 μm, or from 1 μm to 75 μm, or from 1 μm to 50 μm, or from 1 μm to 40 μm.

In an embodiment, the stable aqueous suspension includes a viscosity modifier in an amount from 0.1% (w/w) to 5% (w/w). A “viscosity modifier,” as used herein, is a component that when added to an aqueous medium (or water), increases the viscosity of the aqueous medium (or water). The viscosity modifier is present in an amount sufficient to stabilize the potassium pentaborate particles in the aqueous suspension. Nonlimiting examples of suitable viscosity modifiers include clays, polysaccharides, acrylates, and combinations thereof. Nonlimiting examples of suitable clays include natural and/or synthetic layered silicates such as montmorillonite, bentonite, kaolinite, kaolin, mica, hectorite, sauconite, fluorohectorite, saponites, attapulgite, sepiolite, beidellite, ledikite, nontronite, volkonskoite, stevensite, vermiculite, halloysite, talc, pyrophillite, palygorskite, illite, phlogopite, biotite, chlorite, nacrite, dickite, suconite, magadiite, kenyaite, Laponite®, tainiolite, synthetic fluoromica and combinations thereof. The viscosity modifier allows the stable aqueous suspension to be sprayed, pumped, or poured.

Nonlimiting examples of suitable polysaccharides for viscosity modifier include natural sugars (e.g., xanthan gum, glucose, fructose, galactose, mannose, arabinose, ribose, and xylose); alternatively or additionally, in an embodiment, a polysaccharide comprises one or more non-natural amino acids (e.g. modified sugars such as 2′-fluororibose, 2′-deoxyribose, and hexose).

Nonlimiting examples of suitable acrylates (for viscosity modifier) include methyl acrylate, ethyl acrylate, ethyl methacrylate, propyl acrylate, propyl methacrylate, butyl acrylate, butyl methacrylate methyl methacrylate, methyl ethacrylate, octyl acrylate, lauryl acrylate, stearyl acrylate, behenyl acrylate, and combinations thereof.

In a further embodiment, the viscosity modifier is a combination of two viscosity modifiers, a first viscosity modifier that is a clay (such as bentonite clay) and a second viscosity modifier that is a polysaccharide (such as xanthan gum). The stable aqueous suspension includes the first viscosity modifier and the second viscosity modifier in an aggregate amount from 0.1% (w/w), or 1%, or 2%, or 3%, to 4%, or 5% (w/w).

In an embodiment the stable aqueous suspension includes a dispersant. Non-limiting examples of dispersants include acrylic polymers, water soluble polymeric dispersants, such as polyethylene oxide, hydrolyzed polyvinyl acetates, polyvinyl pyrrolidone, polyacrylamide, and polyvinyl alcohol.

In an embodiment, the stable aqueous suspension has a pH from 6.5 to 8.5. In a further embodiment, the stable aqueous suspension has a pH from 6.5, or 6.6, or 6.7, or 6.8, or 6.9, or 7.0, or 7.1, or 7.2, or 7.3, or 7.4, or 7.5 to 7.6, or 7.7, or 7.8, or 7.9, or 8, or 8.1, or 8.2, or 8.3, or 8.4, or 8.5.

In an embodiment, the stable aqueous suspension has a dynamic viscosity from 1000 cP to 7000 cP at 19.3° C. In a further embodiment, the stable aqueous suspension has a dynamic viscosity of from 1000 cP, or 1200 cP, or 1400 cP, or 1600 cP, or 1800 cP, or 2000 cP, or 2200 cP, or 2400 cP, or 2600 cP, or 2800 cP, or 3000 cP, or 3200 cP, or 3400 cP, or 3600 cP, or 3800 cP, or 4000 cP, or 4200 cP, or 4400 cP, or 4600 cP, or 4800 cP to 5000 cP, or 5200 cP, or 5400 cP, or 5600 cP, or 5800 cP, or 6000 cP, or 6200 cP, or 6400 cP, or 6600 cP, or 6800 cP, or 7000 cP.

In an embodiment, the stable aqueous suspension has a bulk density from 1.2 to 1.4 g/mL.

In an embodiment, the stable aqueous suspension with suspended particles of potassium pentaborate has one, some, or all of the following components:
(i) from 8% (w/w) to 13% (w/w), or from 9% (w/w) to 12% (w/w), or from 9% (w/w) to 11% (w/w), or from 9% (w/w) to 10% (w/w) boron; and/or
(ii) from 5% (w/w) to 10% (w/w), or from 6% (w/w) to 9% (w/w), or from 7% (w/w) to 9% (w/w), or from 8% (w/w) to 9% (w/w) potassium oxide; and/or (iii) from 30% (w/w) to 60% (w/w), or from 40% (w/w) to 60% (w/w), or from 50% (w/w) to 60% (w/w), or from 51% (w/w) to 55% (w/w) potassium pentaborate particles; and/or
(iv) from 0.1% (w/w) to 5% (w/w) of viscosity modifier that is bentonite clay and xanthan gum;
and the stable aqueous suspension has one, some, or all of the following properties:
(v) a pH from 6.5 to 8.5, or from 6.5 to 7.5, or from 7.0 to 7.5; and/or
(vi) a dynamic viscosity from 1000 cP to 7000 cP, or from 1000 cP to 5000 cP, or from 2000 to 3000 cP, or from 2000 cP to 2200 cP at 19.3° C.; and/or
(vii) a bulk density from 1.2 to 1.4 g/mL.

The process includes spraying the stable aqueous suspension on a plant at a rate from 0.20 lbs/acre to 0.70 lbs/acre. The term “spraying,” as used herein, is a foliar application of liquid droplets of the stable aqueous suspension onto the plant; foliar application being distinct from application of the stable aqueous suspension to the soil, or to the ground. Stated differently, “spraying” entails applying liquid droplets of the stable aqueous suspension onto (i) the plant leaves, (ii) the plant branches, the (iii) plant stem, and (iv) any combination of (i)-(iii). The rate of 0.20 lbs/acre to 0.70 lbs/acre for the present foliar spray promotes rapid boron uptake and rapid potassium uptake in the plant while avoiding leaf necrosis and toxicity due to over-application. In an embodiment, the process includes spraying the stable aqueous suspension on the plant at a rate from 0.20 lbs/acre to 0.70 lbs/acre, or from 0.22 lbs/acre to 0.68 lbs/acre, or from 0.3 lbs/acre to 0.60 lbs/acre, or from 0.40 lbs/acre to 0.50 lbs/acre, or from 0.43 lbs/acre to 0.47 lbs/acre, or from or 0.45 lbs/acre. In a further embodiment, the process includes spraying the stable aqueous suspension on the plant at a boron rate from 0.20 lbs/acre to 0.70 lbs/acre, or from 0.22 lbs/acre to 0.68 lbs/acre, or from 0.3 lbs/acre to 0.60 lbs/acre, or from 0.40 lbs/acre to 0.50 lbs/acre, or from 0.43 lbs/acre to 0.47 lbs/acre, or from or 0.45 lbs/acre. The term “boron rate,” as used herein the amount of boron applied in pounds boron per acre, or “lbs B/acre.”

The stable aqueous suspension is sprayed on the plant at a rate (or at a boron rate) from 0.20 lbs/acre to 0.70 lbs/acre. Nonlimiting examples of suitable plants upon which the stable aqueous solution is sprayed include alfalfa, apples, asparagus, banana, beans, beets, broccoli, Brussel sprouts, cabbage, carnation, carrots, cauliflower, chrysanthemum, celery, citrus (grapefruit, lemon, lime, orange), clover, cocoa, coconut, coffee, corn, cotton, cucurbits, eggplant, eucalyptus, flaxseed, grapevine, hops, leeks, oats, olive, onion, orca, papaya, parsnip, peas, peppers, poppy, potato, radish, rutabaga, soybean, spinach, sugar cane, sunflower, strawberry, tea, tomato, turnip, and combinations thereof.

In an embodiment, the stable aqueous suspension contains from 30% (w/w) to 60% (w/w) suspended particles of potassium pentaborate and (i) from 8% (w/w) to 13% (w/w) boron and the process includes spraying from 0.25 lbs B/acre to 0.65 lbs B/acre, or from 0.35 lbs B/acre to 0.55 lbs B/acre boron onto the plant. In a further embodiment, the boron is in the form of B₂O₃.

In an embodiment, the stable aqueous suspension contains from 30% (w/w) to 60% (w/w) suspended particles of potassium pentaborate and (ii) from 5% (w/w) to 20% (w/w) potassium oxide and the process includes spraying from 0.1 lbs/acre to 0.50 lbs/acre, or from 0.18 lbs/acre to 0.47 lbs/acre potassium oxide (K₂O) onto the plant.

In an embodiment, the stable aqueous suspension contains from 30% (w/w) to 60% (w/w) suspended particles of potassium pentaborate and (i) from 8% (w/w) to 13% (w/w) boron and (ii) from 5% (w/w) to 20% (w/w) potassium oxide. The process includes spraying from 0.25 lbs B/acre to 0.65 lbs B/acre boron onto the plant and simultaneously spraying 0.18 lbs/acre to 0.47 lbs/acre potassium oxide onto the plant. The boron is in the form of B₂O₃. The stable aqueous suspension is composed of potassium pentaborate “microparticles” (i.e., microparticles having an average particle size from 1 μm to less than 100 μm) suspended in water which advantageously promotes ready foliar uptake of both boron and potassium simultaneously by the plant. In a further embodiment, the process includes simultaneously spraying from 0.25 lbs/acre to 0.65 lbs/acre boron (the boron in the form of B₂O₃) onto the plant and simultaneously spraying 0.18 lbs/acre to 0.47 lbs/acre potassium oxide onto the plant and excluding, or otherwise to the avoiding, the spray of sodium onto the plant.

The present stable aqueous suspension is ready to use, or otherwise ready to apply without the use of organic solvents or “chemicals of concern.” The present stable aqueous suspension is pourable, sprayable, or pumpable, non-oily, and substantially free of organic solvents.

The present stable aqueous suspension of potassium pentaborate particles readily dissolves when diluted with water, making an effective formulation for delivering potassium and boron to the target plant. The stable aqueous suspension is diluted with water in an amount necessary to achieve the targeted rate (pounds diluted aqueous suspension per acre) or a desired boron (B) rate (lbs B/acre). Factors that determine the degree of dilution and the rate (or the boron rate) include sprayer spray rate, sprayer spray pressure, sprayer nozzle size, tank size, and combinations thereof.

When tank size and spray rate are known, Equation 1 (below) is one nonlimiting approach for calculating boron rate (lbs B/acre).

$$The amount of boron composition ( lbs ) = [ ( tank size ( gal ) \div spray rate ( gal / acre ) ) \times desired boron rate ( lbs / acre ) ] \div boron concentration ( w / w \% ) \qquad Equation 1$$

By way of nonlimiting example, for a tank size of 400 gallons, and a spray rate of 20 gal/acre, the amount of XPI 331 (9.8% B w/w, see Table 2 below) to obtain a boron rate of 0.2 lbs/acre can be determined as follows.
(a) Spray coverage for 400 gallon tank÷spray rate 20 gallons/acre=20 acres
(b) Amount of boron needed in the tank: 20 acres×0.2 lbs of B/acre=4.0 lbs of boron
(c) Amount of XPI 331: 4.0 lbs÷0.098=40.8 lbs of XPI 331

Table 1 below shows Equation 1 calculations for determining the amount of XPI 331 (9.8% B w/w, see Table 2 below) to add to tank size of 400 gallons water at a spray rate of 20 gallons/acre in order to obtain boron rates of (i) 0.2 lbs B/acre, (ii) 0.45 lbs B/acre and (iii) 0.7 lbs B/acre.

TABLE 1

| | | Amount of | |
|---|---|---|---|
| | | XPI 331 | Rate |
| Spray rate | Tank size | (9.8% w/w B) | lbs |
| (gallon/acre) | (gallons) | (lbs) | B/acre |
| 20 | 400 | 40.8 | 0.20 |
| 20 | 400 | 91.81 | 0.45 |
| 20 | 400 | 142.86 | 0.70 |

In an embodiment, the process includes diluting the stable aqueous suspension with water to form a diluted stable aqueous suspension. The process includes spraying the diluted aqueous suspension on a plant at a rate from 0.20 lbs/acre to 0.70 lbs/acre, or from 0.22 lbs/acre to 0.68 lbs/acre, or from 0.3 lbs/acre to 0.60 lbs/acre, or from 0.40 lbs/acre to 0.50 lbs/acre, or from 0.43 lbs/acre to 0.47 lbs/acre, or 0.45 lbs/acre. In a further embodiment, the process includes spraying the dilute aqueous suspension on a plant at a boron rate from 0.22 B lbs/acre to 0.68 lbs B/acre, or from 0.3 lbs B/acre to 0.60 lbs B/acre, or from 0.40 lbs B/acre to 0.50 lbs B/acre, or from 0.43 lbs B/acre to 0.47 lbs B/acre, or 0.45 lbs B/acre.

In an embodiment, the diluted stable aqueous suspension contains (i) from 0.008% (w/w) to 13% (w/w) boron and the process includes spraying from 0.25 lbs/acre to 0.65 lbs/acre boron onto the plant. In a further embodiment, the boron is in the form of B₂O₃.

In an embodiment, the diluted stable aqueous suspension contains (ii) from 0.005% (w/w) to 20% (w/w) potassium oxide and the process includes spraying from 0.18 lbs/acre to 0.47 lbs/acre potassium oxide (K₂O) onto the plant.

In an embodiment, the diluted stable aqueous suspension contains (i) from 0.008% (w/w) to 13% (w/w) boron and (ii) from 0.005% (w/w) to 20% (w/w) potassium oxide. The process includes spraying from 0.25 lbs/acre to 0.65 lbs/acre boron onto the plant and simultaneously spraying 0.18 lbs/acre to 0.47 lbs/acre potassium oxide onto the plant. The diluted stable aqueous suspension is composed of potassium pentaborate “microparticles” (i.e., microparticles having an average particle size from 1 μm to less than 100 μm) suspended in water which advantageously promotes ready foliar uptake of both boron and potassium by the plant simultaneously as described above. In a further embodiment, the process includes simultaneously spraying from 0.25 lbs/acre to 0.65 lbs/acre boron and 0.18 lbs/acre to 0.47 lbs/acre potassium oxide and excluding, or otherwise to the avoiding, the spray of sodium onto the plant.

The plant has growth stages. In an embodiment, the process includes first spraying the stable aqueous suspension (or the diluted stable aqueous suspension) on the plant at a first growth stage, and second spraying the stable aqueous suspension (or the diluted stable aqueous suspension) on the plant at a second growth stage. The rate of first spraying and the rate of the second spraying can be the same or can be different. The rate (or boron rate) of the first spraying is from 0.20 lbs/acre to 0.70 lbs/acre, or from 0.22 lbs/acre to 0.68 lbs/acre, or from 0.3 lbs/acre to 0.60 lbs/acre, or from 0.40 lbs/acre to 0.50 lbs/acre, or from 0.43 lbs/acre to 0.47 lbs/acre, or from or 0.45 lbs/acre (hereafter rate/boron rate 1). The rate of the second spraying is from from 0.20 lbs/acre to 0.70 lbs/acre, or from 0.22 lbs/acre to 0.68 lbs/acre, or from 0.3 lbs/acre to 0.60 lbs/acre, or from 0.40 lbs/acre to 0.50 lbs/acre, or from 0.43 lbs/acre to 0.47 lbs/acre, or from or 0.45 lbs/acre.

In an embodiment, the plant is alfalfa. The alfalfa has growth stages of emergence, foliation (first trifoliate, second trifoliate, third, fourth, fifth, and sixth trifoliate), flowering (beginning flowering, full flower), and pod (early pod (early seedpod), late pod (late seedpod), ripe pod (ripe seedpod)). The process includes first spraying the stable aqueous suspension (or the diluted stable aqueous suspension) onto the alfalfa at a flowering growth stage at rate/boron rate 1 and optionally second spraying the stable aqueous suspension (or diluted stable aqueous suspension) at the pod growth stage at rate/boron rate 1.

In an embodiment, the plant is soybean. The soybean has growth stages emergence (VE), trifoliate (first trifoliate (V1), second trifoliate (V2), third, fourth, fifth, and sixth trifoliate (V3, V4, V5, V6)), bloom (beginning bloom (R1), full bloom (R2)), pod (beginning pod (R3), full pod (R4)), seed (beginning seed (R5), full seed (R6)), and maturity (beginning maturity (R7), full maturity (R8)). The process includes first spraying the stable aqueous suspension (or the diluted stable aqueous suspension) onto the soybean at a bloom growth stage at rate/boron rate 1, and second spraying the stable aqueous suspension (or diluted stable aqueous suspension) onto the soybean at a pod growth stage at rate/boron rate 1.

In an embodiment, the plant is corn. The corn has growth stages emergence (VE), collar (first leaf collar (V1), second leaf collar (V2), third leaf collar (V3), nth leaf collar (Vn)), tasseling (VT), silking (R1), blister (R2), milk (R3), dough (R4), dent (R5), and maturity (R6). The process includes first spraying the stable aqueous suspension (or diluted stable aqueous suspension) onto the corn at a collar growth stage at rate/boron rate 1, and second spraying the stable aqueous suspension (or the diluted stable aqueous suspension) onto the corn at a growth stage of silking at rate/boron rate 1.

### EXAMPLES

The following examples are presented by way of illustration and are not meant to be limiting in any way.

Materials used in the inventive examples and comparative samples are provided in Table 2 below.

TABLE 2
Materials

| Product | Composition | Source |
|---|---|---|
| Aspire | Potassium Chloride (99-99.5%) + Calcium | The Mosaic |
| | Hexaborate Pentahydrate (1-5%) + Sodium | Company |
| | Tetraborate Anhydrous, (1-5%) | |
| Granubor | Sodium tetraborate pentahydrate | US Borax |
| | Na₂B₄O₇•5H₂O, boron 15% | |
| Liquid | Aqueous polyborate solution, boric acid | WinField |
| 10% | 56-58%, monoethanolamine, 19-21% | Solutions |
| | pH 7.8-9.4 | LLC |
| Solubor | Mixture of Orthoboric Acid, H₃BO₃ | US Borax |
| | Disodium Tetraborate Pentahydrate, | |
| | Na₂B₄O₇•5H₂O and Disodium | |
| | Decaborate Decahydrate, | |
| | Na₂B₁₀O₁₆•10H₂O | |
| | Water soluble boron, B % (w/w), 17.2-17.8 | |
| | Equivalent B₂O₃, % (w/w), 55.4-57.3 | |
| | Na₂O, 9.5-10.5% (w/w) | |
| Solubor | Aqueous suspension of sodium borate for | US Borax |
| Flow | foliar spray Pentaboron sodium octaoxide | |
| | pentahydrate | |
| Ulexite | Sodium Calcium Penta-borate Octahydrate | Bisley |
| Suspen- | Stable aqueous suspension of particles of | US Borax |
| sion 1 | potassium pentaborate | |
| | (K₂O•(B₂O₃)₅•8H₂O) | |
| | 9.8% (w/w) boron | |
| | 8.8% (w/w) K₂O | |
| | 7.17 pH | |
| | xanthan gum | |
| | bentonite clay | |

### Trial 1—University of Wisconsin—Alfalfa

A trial with alfalfa seedlings was conducted to demonstrate foliar uptake and assimilation of the present stable aqueous suspension containing suspended particles of potassium pentaborate compared to conventional sodium/boron foliar solutions. The soil was classified as loamy sand soil with pH 6.9 and a soil boron content of 0.2 ppm. Alfalfa was planted on April 23rd. The first harvest occurred on July 16th. Treatments occurred on July 23rd (“dry,” Granubor granules of sodium borate applied to soil) and July 27th (foliar). The second harvest occurred on August 25th.

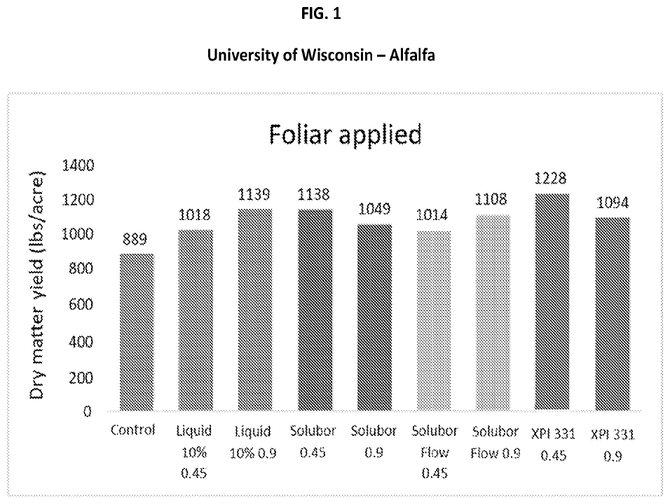

For the foliar application on July 27th, a sprayer was calibrated to 40 psi. 198 ml of Suspension 1 (from Table 1) was diluted into 7.6 L of water to form a diluted stable aqueous suspension of potassium pentaborate particles (“XPI 331” in Table 3 and FIG. 1). Based on the spray rate of the sprayer and the sprayer nozzle size, the stable aqueous suspension (XPI 331) and the comparative examples were diluted to obtain the boron rates in Table 3 below. Comparative boron solutions and the XPI 331 (inventive example) were sprayed onto alfalfa seedlings at the boron rates shown in Table 3 below. No nutrients other than those in the comparative samples and the inventive example were applied.

TABLE 3

| | | Boron rate | |
|---|---|---|---|
| Trmt | Product | (lbs/acre) | Method of application |
| CS1 | Control | 0 | N/A |
| CS2 | Granubor | 0.5 | Soil/Dry --After |
| CS3 | Granubor | 1.0 | first cut |
| CS4 | Granubor | 3.0 | |
| CS5 | Ulexite | 0.5 | |
| CS6 | Ulexite | 1.0 | |
| CS7 | Ulexite | 3.0 | |
| CS8 | Aspire | 1.0 | |
| CS9 | Liquid 10% | 0.45 | Foliar--After |
| CS10 | Liquid 10% | 0.9 | first cut |
| CS11 | Solubor | 0.45 | |
| CS12 | Solubor | 0.9 | |
| CS13 | Solubor Flow | 0.45 | |
| CS14 | Solubor Flow | 0.9 | |
| IE15 | XPI 331 | 0.45 | |
| CS16 | XPI 331 | 0.9 | |

CS—comparative sample,
IE—inventive example

The results of the foliar spray application for comparative samples and inventive example are shown in FIG. 1.

The trial shows that the lower boron rate for XPI 331 (0.45 lbs B/acre) resulted in the highest alfalfa yield (1228) when compared to (i) the higher boron rate for XPI 331 (0.9 lbs B/acre and alfalfa yield 1084) and (ii) the highest performing comparative sample of sodium boron-based composition (Liquid 10%0.9 lbs B/acre, alfalfa yield 1139).

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
providing a stable aqueous suspension comprising from 30% (w/w) to 60% (w/w) suspended particles of potassium pentaborate; and
spraying the suspension on a plant at a rate from 0.20 lbs/acre to 0.70 lbs/acre.

2. The process of claim 1 wherein the plant has leaves, the process comprising
spraying the suspension onto the leaves of the plant.

3. The process of claim 1 comprising
providing a stable aqueous suspension comprising particles of potassium pentaborate having an average particle size from 1 micron to less than 100 microns.

4. The process of claim 1 comprising
providing a stable aqueous suspension comprising
(i) from 8% (w/w) to 13% (w/w) boron; and
spraying from 0.25 lbs/acre to 0.65 lbs/acre boron onto the plant.

5. The process of claim 1 comprising
providing a stable aqueous suspension comprising
(ii) from 5% (w/w) to 20% (w/w) potassium oxide; and
spraying from 0.18 lbs/acre to 0.47 lbs/acre potassium oxide onto the plant.

6. The process of claim 5 comprising
simultaneously spraying from 0.25 lbs/acre to 0.65 lbs/acre boron and from 0.18 lbs/acre to 0.47 lbs/acre potassium oxide onto the plant.

7. The process of claim 1 comprising
diluting the stable aqueous suspension with water;
forming a diluted stable aqueous suspension; and
spraying the diluted stable aqueous suspension on a plant at a rate from 0.20 lbs/acre to 0.70 lbs/acre.

8. The process of claim 7 comprising
providing a diluted stable aqueous suspension comprising
(i) from 0.008% (w/w) to 13% (w/w) boron; and
spraying from 0.25 lbs/acre to 0.65 lbs/acre boron onto the plant.

9. The process of claim 7 comprising
providing a diluted stable aqueous suspension comprising
(ii) from 0.005% (w/w) to 20% (w/w) potassium oxide; and
spraying from 0.18 lbs/acre to 0.47 lbs/acre potassium oxide onto the plant.

10. The process of claim 9 comprising
simultaneously spraying from 0.25 lbs/acre to 0.65 lbs/acre boron and from 0.18 lbs/acre to 0.47 lbs/acre potassium oxide onto the plant.

11. The process of claim 1 wherein the plant has growth stages, the process comprising
first spraying the stable aqueous suspension on the plant at a first growth stage; and
second spraying the stable aqueous suspension on the plant at a second growth stage.

12. The process of claim 1 wherein the plant is alfalfa, and the alfalfa has growth stages, and the process comprises
spraying the stable aqueous suspension onto the alfalfa at a growth stage of flowering.

13. The process of claim 1 wherein the plant is soybean, and the soybean has growth stages, the process comprising
first spraying the stable aqueous suspension onto the soybean at a growth stage of flowering; and
second spraying the stable aqueous suspension onto the soybean at a growth stage of pod.

14. The process of claim 1 wherein the plant is corn, and the corn has growth stages, the process comprising
first spraying the stable aqueous suspension onto the corn at a growth stage of collar; and
second spraying the stable aqueous suspension onto the corn at a growth stage of silking.
